(19) United States
(12) Patent Application Publication
(10) Pub. No.: US 2006/0082441 A1
(43) Pub. Date: Apr. 20, 2006

(54) Paging device and method of use

(76) Inventor: Michael Papamihalis, Flushing, NY (US)

Correspondence Address: Raymond M. Galasso;Simon, Galasso & Frantz PLC, P.O. Box 26503, Austin, TX, 78755-0503, US

(21) Appl. No.: 10/968,528

(22) Filed: Oct. 19, 2004

(51) Int. Cl. H04Q 7/00

(52) U.S. Cl. 340/7.6; 340/7.63

(57) ABSTRACT

A paging device and method of use are provided. In one form, a paging device for facilitating intimate contact at a stimulation site of a wearer includes a pager including a vibration mechanism responsive to a pager signal received by the pager. The paging device further includes a housing enclosing the pager and the vibration mechanism. The housing conforms to an undergarment of a wearer to provide intimate contact along a stimulation site of the wearer.

### FIELD OF THE DISCLOSURE

The invention relates generally to paging devices, and more particularly to an intimate paging device and method of use.

### BACKGROUND

Paging systems are efficient conduits capable of rapidly notifying recipients of incoming messages. Early paging systems allowed users to alert recipients that a phone call was essential and must be returned using the a phone number entered by the sender. Some traditional paging networks were based on analog communication systems and transmitted small amounts of data during a transmission to alert a recipient to call a sender.

As networks evolved, extensive messaging and character sets were allowed enabling a sender to discretely communicate with a recipient and provide more robust messages. For example, some conventional systems allow for short-range messaging (i.e. Bluetooth, 802.x, etc.) allowing a user to locate a potential recipient proximal to a sender and initiate a communication with an identified recipient. However, these advanced systems lack in the ability to use conventional paging networks to provide intimate contact between users.

### BRIEF DESCRIPTION OF THE DRAWINGS

Other advantages, features and characteristics of the invention, as well as methods, operation and functions of related elements of structure, and the combinations of parts and economies of manufacture, will become apparent upon consideration of the following description and claims with reference to the accompanying drawings, all of which form a part of the specification, wherein like reference numerals designate corresponding parts in the various figures, and wherein:

FIG. 1 is front perspective view of an intimate paging device according to one embodiment of the invention;

FIG. 2 is side perspective view of an intimate paging device according to one embodiment of the invention; and

FIG. 3 illustrates a top perspective view of an intimate paging device according to one embodiment of the invention.

### DETAILED DESCRIPTION OF THE FIGURES

The present invention is directed toward a paging device and use thereof. In one form, a paging device facilitates providing intimate contact when worn by a user. The paging device includes a vibrator or vibration mechanism provided in association with a pager that may be remotely activated via a paging network. The paging device may be placed proximal to an undergarment (i.e. underwear, brazier, shirt, pants, etc.) at desired stimulation site. In this manner, a user may receive a page via the paging network and the vibration mechanism may stimulate the user at a desired stimulation site.

In a particularized form, an intimate paging device includes a pager and vibration mechanism coupled to a plastic insert that may be positioned along a user's body at a desired stimulation site. The intimate paging device is responsive to a pager signal received by the pager a housing enclosing the pager and the vibration mechanism. The pager and vibration mechanism are provided within a housing operable to conform to an undergarment of a wearer to provide intimate contact along a stimulation site of the wearer. The vibration mechanism is integrated as a portion of the housing and battery compartment houses a battery and may be externally access to allow for easy replacement of batteries as needed.

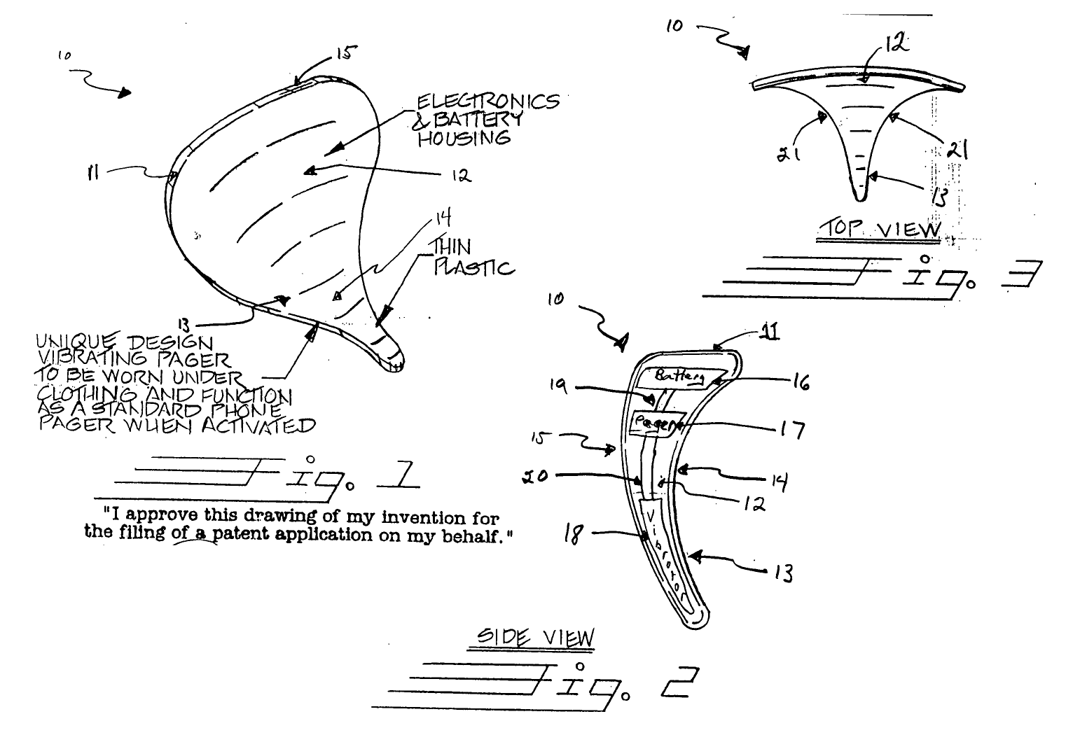

FIG. 1 is front perspective view of an intimate paging device according to one embodiment of the invention. An intimate paging device 10 includes a housing 11 for housing electronics such as a pager receiver, batteries, vibrator(s) or vibration mechanism(s), conductive elements, or other electronics or components (not expressly shown). Housing 11 may be formed from various types of materials or combinations of materials and in one form may include a molded plastic material and that is shaped based on the use or desired stimulation site for intimate paging device 10. For example, housing 11 may be provided in a shape such as triangular-like, circular-like, etc and the like. Additionally, housing 11 may also be made of are water resistant materials and/or materials that and may be cleaned from time using conventional soaps. In one form, shape of housing 11 may be similar to a sports cup or genital protective device sized to substantially cover a user's genitals.

Intimate paging device 10 further includes a main body 12 and an elongated portion 13. Main body 12 may be sized to house or contain active paging components such as a pager and battery compartment and elongated portion 13 including a vibration mechanism such as a vibrator. Elongated portion 13 may be sized to extend along a wearer's genitalia and may include, or be coupled to, a pager activated vibrator or vibration mechanism (not expressly shown). In one embodiment, elongated portion 13 may include a thinner material than main body 12 to provide enhanced stimulation and comfortable wear along a stimulation site. Intimate paging device 10 further includes a contact surface 14 for contacting a genitalia regions and an exterior 15. Either side may include a coupling mechanism for coupling intimate paging device 10 to an interior or exterior portion of a wearer's clothing or undergarment.

During use, a wearer of intimate paging device 10 may place intimate paging device 10 along a stimulation site (not expressly shown) such as genitalia or other stimulation pleasing location. A page identifying the pager may be initiated through a user entering a pager number of intimate paging device 10 and a page is sent to intimate paging device 10. Upon sending a page, a page is received by intimate paging device 10 and a vibration mechanism responsive to a page is activated and provides vibrations along elongated portion 13 and contact surface 14. In this manner, a wearer may be remotely stimulated by an individual or paging party via a wireless network and providing a level of intimacy between the wearer and paging party.

FIG. 2 is side perspective view of an intimate paging device according to one embodiment of the invention. Intimate paging device 10 includes housing 11, having main body 12 for housing electronics such as a battery compartment 16 and pager 17. Battery compartment 16 is electrically coupled to pager 17 via first conductors 19 and provides power to pager 17 and a vibrator 18. Battery compartment 16 includes an access panel (not expressly shown) provided in association with housing 11 allowing a user to replace batteries as needed.

Vibrator 18 is coupled to pager 17 via second conductive conductors 20 and provides electrical signals via second conductors 20 to activate vibrator 18. Elongated portion 13 extends away from main body 12 and includes a vibration mechanism such as vibrator 18 integrated as a portion of elongated portion 13 to provide stimulation along contact surface 14. Elongated portion 13 includes a curved or tapered manner to conform against a wearer's body.

In one embodiment, contact surface 14 of elongated portion may include various types and/or combinations of materials and may be provided having one or more thickness. For example, a thicker plastic material may be provided along an upper portion of elongated portion 13 and a thinner plastic may be provided along a lower portion of elongated portion 13. In this manner, vibrator 18 when activated may provide enhanced stimulation to a wearer along a stimulation site. In another embodiment, elongated portion 13 may include a softer plastic or rubber based material that may conform to a wearer's stimulation site to provide closer contact along a stimulation site. As such, vibration may be enhanced along contact surface 14 upon vibrator 18 being activated.

In one embodiment, pager 17 and vibrator 18 may include electronic paging components used by conventional pagers operable to communicate with one or more type of paging network such as a conventional analog paging network, digital network including a short messaging service (SMS), or other various types of paging or communications network including, but not limited to, cellular networks, personal communications networks, GSM networks, etc.

For example, pager 17 includes a radio that listens to a station or frequency. A radio transmitter broadcasts signals over a specific frequency and is detected by pager 17. In one embodiment, pager 17 includes a built-in receiver tuned to a specific frequency broadcast from the transmitter. However, other embodiments may include using multiple frequency detection device.

Pager 17 may include a specific identification sequence called a Channel Access Protocol (CAP) code where pager 17 listens for its unique CAP code. When it detects the code it activates vibrator 18. Pager 17 may include a simple radio antenna (not expressly shown), made from a coil of wire wrapped around a metal core, picks up the signal from the master transmitter. A microprocessor for pager 17, compares the processed signal against a CAP code for pager 17. When the signal matches the CAP code, pager 17 activates vibrator 18.

Housing 11 may also include waterproofing to insulate a wearer or user of intimate paging device 10 from receiving electrical shock. Intimate paging device 10 may also be provided in various sizes to ensure adequate coverage of a wearer's desired body part or stimulation site as needed. In one embodiment, vibrator 18 includes a small weight attached to a motor. The weight is mounted off-center on the motor's spindle and when vibrator 18 is activated, the motor spins the weight (at approximately 100 to 150 rpm), causing a strong vibration.

During use, a wearer may place intimate paging device 10 along a stimulation site (not expressly shown) such as genitalia or sensitive location. A page identifying the pager may be initiated through a user entering a pager number for intimate paging device 10 and a page is sent to intimate paging device 10. Upon sending a page, a page is received by intimate paging device 10 and a vibration mechanism responsive to a page is activated and provides vibrations along elongated portion 13 and contact surface 14.

In one embodiment, intimate paging device 10 may activate for a predetermined period of time based on either a digitally stored activation period or an activation period provided by via components configured to provide a specific time constant for activating vibrator 18. As such, an activation time period for activating vibrator 18 is determined and activated accordingly. In one embodiment, a wearer may provide a time period and speed setting for activating vibrator 18. For example, a vibration period and/or vibration speed setting may be provided (not expressly shown) allowing the wearer of intimate paging device 10 to adjust the output of vibrator 18. In another embodiment, a calling or paging party may provide an input via a telephone handset (i.e. keyboard, user interface) to provide the vibration speed and duration for vibrator 18. In this manner, pager 18 may include a processor capable of determining logic encoded within a signal provided by a paging network and including the vibration speed and duration input by a paging party or caller. In this manner, vibration speed and duration may be either locally or remotely controlled.

FIG. 3 illustrates a top perspective view of an intimate paging device according to one embodiment of the invention. Intimate paging device 10 includes a housing 11 having a main body 12 including an elongated portion 13 having curved regions 21 to allow for maintaining placement along a genital region.

Note that although an embodiment of the invention has been shown and described in detail herein, along with certain variants thereof, many other varied embodiments that incorporate the teachings of the invention may be easily constructed by those skilled in the art. Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. Accordingly, the invention is not intended to be limited to the specific form set forth herein, but on the contrary, it is intended to cover such alternatives, modifications, and equivalents, as can be reasonably included within the spirit and scope of the invention.

What is claimed is:

1. A paging device for facilitating intimate contact at a stimulation site of a wearer comprising:
a pager including a vibration mechanism responsive to a pager signal received by the pager; and
a housing enclosing the pager and the vibration mechanism, the housing operable to conform to an undergarment of a wearer to provide intimate contact along a stimulation site of the wearer.

2. The device as recited in claim 1 wherein the housing comprises a molded plastic material operable to be inserted along an interior portion of the undergarment.

3. The device as recited in claim 2 wherein the vibration mechanism comprises a vibrator including a vibrator element integrated as a part of the molded plastic material.

4. The device as recited in claim 3 further comprising the molded plastic material including a contact surface positioned along an elongated portion of the housing.

5. The device as recited in claim 4 further comprising a battery compartment sized to house a battery sufficient to power the pager and the vibration mechanism.

6. The device as recited in claim 5 wherein the battery compartment includes an access panel coupled to an exterior portion of the housing.

7. The device as recited in claim 2 wherein the molded plastic insert includes a shape sized to fit along a portion of a contour the wearer.

8. The device as recited in claim 1 further comprising:
a main body positioned along an upper portion of the housing and including the pager and a battery compartment; and
an elongated portion positioned along a lower portion of the housing and including the vibration mechanism, the elongated portion formed to provide intimate contact with a portion of the wearer's genital region.

9. The device as recited in claim 8 further comprising the elongated portion including at least one contoured surface shaped to fit along a portion of the wearer.

10. The device as recited in claim 1 vibrator mechanism means for stimulating the wearer at a desired stimulation site.

11. A method of stimulating a wearer of an intimate paging device operable to be coupled to a stimulation site of the wearer to provide intimate contact along the stimulation site upon receipt of a page via a wireless network, the method comprising:
entering a pager number of an intimate paging device using a telecommunications network; and
sending a page to the intimate paging device operable to process the page and stimulate a wearer of the intimate paging device along a stimulation site.

12. The method as recited in claim 11 further comprising:
receiving the page at the intimate paging device; and
activating a vibration mechanism in response to receiving the page.

13. The method as recited in claim 11 further comprising:
determining an activation time period for activating the vibration mechanism; and
activating the vibration mechanism based on the determined time period.

14. The method as recited in claim 13 receiving an input by a wearer to vary the time period.

15. The device of claim 14 further comprising varying an electrical component in response to the input.

16. The device of claim 11 further comprising:
determining a vibration speed for controlling a vibration speed of the vibration mechanism; and
activating the vibration mechanism based on the vibration speed.

17. An intimate paging device operable to be coupled to a stimulation site of a wearer to provide intimate contact along the stimulation site upon receipt of a page via a wireless network, the intimate paging device comprising:
a clothing insert including a housing enclosing a pager and a vibration mechanism, the clothing insert operable to be placed along an undergarment proximal to a stimulation site of a wearer; and
wherein the housing comprises:
a main body including the pager and a battery compartment;
a elongated portion positioned along a lower region of the housing and including the vibration mechanism, the elongated portion formed to promote intimate contact along the stimulation site; and
wherein the battery compartment includes an access panel allowing exterior external access to a battery.

18. The device of claim 17 wherein the elongated portion comprises a contact surface including material operable to transfer vibrations provided by the vibration mechanism.

19. The device of claim 17 wherein the vibrator includes a vibrator housing sized to fit a vibration element coupled to the vibration mechanism and operable to promote increased levels of vibration.

20. The device of claim 17 wherein the elongated portion includes a soft plastic material operable to transmit vibrations along the stimulation site.
